(19) United States
(12) Patent Application Publication
(10) Pub. No.: US 2010/0124394 A1
(43) Pub. Date: May 20, 2010

(54) PROCESS FOR CONNECTING FIBERS AND CONNECTED OPTICAL ASSEMBLY

(76) Inventors: David Wayne Meek, Ft. Worth, TX (US); Scott Eric Semmler, Roanoke, TX (US); Michael Heath Rasmussen, Keller, TX (US)

Correspondence Address: CORNING INCORPORATED, INTELLECTUAL PROPERTY DEPARTMENT, SP-TI-3-1, CORNING, NY, 14831, US

(21) Appl. No.: 12/273,707

(22) Filed: Nov. 19, 2008

(51) Int. Cl. G02B 6/38

(52) U.S. Cl. 385/73

(57) ABSTRACT

A process for connecting optical transmission media such as fibers and connected assembly made by using the process. The invention features the use of an intermediate index-matching material between the connecting end faces and a lubricant during the connecting process. The resultant assembly exhibits lower insertion loss and reflectance loss, as well as lower loss variation compared to connection using the intermediate, index-matching material only.

### TECHNICAL FIELD

The present invention relates to processes for connecting optical transmission media such as optical fibers and connected optical assembly by using such methods. The present invention is useful, for example, in connecting optical fibers in the field.

### BACKGROUND

A common method for connecting optical fibers is by means of physical connection, whereby optical fibers are placed against each other end to end and thereby connected. Examples of connection components that utilize such physical connection include mechanical splices and optical connectors. In general, mechanical splices are effective when components are connected permanently, while optical connectors are effective when connected components are detached and reattached frequently. Both are widely utilized in their respective applications. Both mechanical splices and optical connectors effect physical connection by applying pressure on the end faces of optical fibers in the axial direction.

In such physical connection, the positioning accuracies and end shapes of optical fibers affect the connection characteristics significantly. If the angles of end faces are offset or end faces are rough, for example, air enters between the joined ends of optical fibers and increases Fresnel reflection at connected end faces, which results in increased connection loss.

Various methods to address this issue have been developed. One proposed method is to finely grind the end faces of optical fibers or both the end faces of optical fibers and ferrules. However, grinding requires a lot of time and cost and is not suitable for general connection applications.

Also, methods to connect optical fibers that have been cut but not ground are being examined. One proposed method is to connect optical fibers by applying, on the end faces to be connected, a liquid or grease refractive-index-matching agent having a refractive index equal or close to that of the optical fiber core and acceptable transmission at the transmitted wavelength. This method involves application of a refractive-index-matching fluid on the end faces of optical fiber and then joining the optical fibers, thereby preventing intrusion of air between the connected end faces, avoiding Fresnel reflection caused by air, and ultimately reducing connection loss.

In addition, an optical connection structure comprising a solid viscous connection member having refractive-index matching property adherently disposed in a single layer state between the end faces of mutual opposing optical transmission media or between the end face of an optical transmission medium and an optical component that are mutually opposing has been proposed. However, the present inventors have found that, albeit the use of such index-matching solid piece can decrease the transmission loss compared to bare fiber-to-fiber connection, both transmission loss and transmission loss variability can be nonetheless unacceptably high, leading to low performance of the connected optical assembly.

Hence, there is a need to improve the light transmission loss and transmission loss variability in an optical connection involving the use of a solid medium between the connecting end faces. The present invention satisfies this need.

### SUMMARY

According to a first aspect of the present invention, provided is a method for mechanically and optically connecting a first end face of a first optical transmission medium and a second end face of a second optical transmission medium, comprising:

(A) providing a first enclosure capable of housing a first end portion of the first optical transmission medium comprising the first end face;

(C) providing an intermediate index-matching material between the first end face and the second end face;

(D) providing a lubricating material between the first end portion of the first optical transmission medium and the first enclosure; and

(E) moving the first end face of the first optical transmission medium relative to the second end face of the second optical transmission medium by engaging the first end portion with the first enclosure, thereby bringing the first end face of the first optical transmission medium and the second end face of the second optical transmission medium into contact with the intermediate index-matching material.

In certain embodiments of the process according to the first aspect of the present invention, the process further comprises the following step (B) before step (E) is carried out:

(B) providing a second enclosure capable of housing a second end portion of the second optical transmission medium comprising the second end face.

In certain embodiments of the process according to the first aspect of the present invention, the intermediate index-matching material is a solid material at room temperature (25° C.).

In certain embodiments of the process according to the first aspect of the present invention, the first optical transmission medium comprises a core of a first optical waveguide, and the second optical transmission medium comprises a core of a second optical waveguide.

In certain embodiments of the process according to the first aspect of the present invention, the intermediate index-matching material provided in step (C) is a deformable organic polymer.

In certain embodiments of the process according to the first aspect of the present invention, the lubricating material provided in step (D) comprises a liquid, a gel, a suspension, or an emulsion.

In certain embodiments of the process according to the first aspect of the present invention, the lubricating material comprises a lubricating oil.

In certain embodiments of the process according to the first aspect of the present invention, the lubricating material comprises a fugitive lubricant.

In certain embodiments of the process according to the first aspect of the present invention, step (D) comprises applying the lubricating material to the external surface of the first end portion of the first optical transmission medium, and/or to the internal surface of the first enclosure. In certain more specific embodiments, at least part of the lubricating material is applied in situ immediately before the first end face and the second end face are connected. In certain specific embodiments, at least part of the lubricating material is applied well before the first end face and the second end face are connected.

In certain embodiments of the process according to the first aspect of the present invention, at least part of the lubricating material is included in (i) the material forming the external surface of the first end portion of the first optical transmission medium, and/or (ii) the material forming the internal surface of the first enclosure.

In certain embodiments of the process according to the first aspect of the present invention, the first enclosure provided in step (A) is a splice.

In certain embodiments of the process according to the first aspect of the present invention, the intermediate index-matching material provided in step (C) provides an optical pathlength between the first end face and the second end face of at most 100 μm, in certain embodiments at most 80 μm, in certain embodiments at most 50 μm, in certain embodiments at most 30 μm.

In certain embodiments of the process according to the first aspect of the present invention, step (E) comprises locking the position of the first end portion of the first optical transmission medium relative to the first enclosure.

According to a second aspect of the present invention, provided is an optical assembly comprising a first optical transmission medium and a second optical transmission medium, which are optically and mechanically connected via a first end face of the first optical transmission medium and a second end face of the second optical transmission medium, comprising:

(a) a first enclosure housing a first end portion of the first optical transmission medium comprising the first end face;

(c) an intermediate index-matching material between the first end face and the second end face; and

(d) a lubricating material between the first end portion of the first optical transmission medium and the first enclosure.

In certain embodiments of the optical assembly according to the second aspect of the present invention, the assembly further comprises:

(b) a second enclosure housing a second end portion of the second optical transmission medium comprising the second end face.

In certain embodiments of the optical assembly according to the second aspect of the present invention, the first optical transmission medium comprises a core of a first optical waveguide, and the second optical transmission medium comprises a core of a second optical waveguide.

In certain embodiments of the optical assembly according to the second aspect of the present invention, the intermediate index-matching material (c) is a deformable organic polymer.

In certain embodiments of the optical assembly according to the second aspect of the present invention, the lubricating material (d) comprises a liquid, a gel, a suspension, or an emulsion.

In certain embodiments of the optical assembly according to the second aspect of the present invention, the lubricating material comprises a lubricating oil.

In certain embodiments of the optical assembly according to the second aspect of the present invention, the lubricating material is present substantially only between the external surface of the first end portion of the first optical transmission medium, and the internal surface of the first enclosure.

In certain embodiments of the optical assembly according to the second aspect of the present invention, at least part of the lubricating material is included in (i) the material forming the external surface of the first end portion of the first optical transmission medium, and/or (ii) the material forming the internal surface of the first enclosure.

In certain embodiments of the optical assembly according to the second aspect of the present invention, the first enclosure comprises a splice.

In certain embodiments of the optical assembly according to the second aspect of the present invention, the intermediate index-matching material (c) is bonded to the second end face of the second optical transmission medium.

In certain embodiments of the optical assembly according to the second aspect of the present invention, the intermediate index-matching material (c) provides an optical pathlength between the first end face and the second end face of at least 10 μm, in certain embodiments at least 15 μm, in certain embodiments at least 20 μm, in certain embodiments at least 25 μm, in certain embodiments at least 30 μm, in certain embodiments at least 40 μm.

Certain embodiments of the first and/or second aspects of the present invention have one or more of the following advantages. First, transmission loss in the connected optical assembly is reduced compared to a lubricant-free connecting solution involving use of an intermediate solid piece between the connecting end faces. Second, transmission loss variability is reduced, due to a more reliable, more duplicable connection achieved by the use of a lubricant. Third, connection is eased and facilitated by the presence of the lubricant, allowing for a more expedient and a more reliable field connection process. Fourth, compared to the connection using index-matching oil between the connecting end faces only, the use of a solid connecting medium results in a more robust structure with a longer life and better transmission loss.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a schematic illustration of an optical assembly according to one embodiment of the present invention.

FIG. 2 is a schematic illustration of an optical assembly according to another embodiment of the present invention before the optical connection is completed.

FIG. 3 is a schematic illustration of the optical assembly as illustrated in FIG. 2 upon completion of the connection of the two fibers.

### DETAILED DESCRIPTION

As used herein, “optical transmission medium” means a medium through which light is transmitted. The light transmission could be for various purposes, including but not limited to: signal and information transmission, power transmission, or both. When the light is transmitted, it may remain substantially unchanged, or subjected to modification, manipulation, interaction with other light, and the like, as part of the function of the light transmission medium. Thus, examples of the light transmission medium in the present application can include, but are not limited to: optical waveguides (including but not limited to optical fibers), optical fibers, optical lenses, optical signal generators, optical signal processors, optical signal receivers, and the like. The present invention can be used in connection with any and all of these optical transmission media, or various combinations thereof. For example, the present invention can be used in waveguide-to-waveguide connection, fiber-to-waveguide connection, fiber-to-fiber connection, fiber-to-lens connection, lens-to-lens connection, and the like. The present invention will be illustrated below in the context of optical fiber to optical fiber connection. However, one of ordinary skill in the art understands that, in light of the teachings of the present application, the invention may be adapted for use in connection with other optical transmission media as well.

Optical fibers have been used widely, especially in the telecommunications industry to replace older generation telecommunication lines. Though optical fibers can be deployed for a long distance without the need of connection between fibers without significant signal loss, connection between fibers is inevitable in an optical fiber network, or between the device-network interfaces. Many connection solutions have been developed and used, including, e.g., fiber splicing, fiber connector, and the like. It is desired that the connection would have good longterm and short-term stability, sufficient mechanical strength, acceptable attenuation, and high workability.

Attenuation in the fiber-to-fiber connection can be minimized if light transmitted from the feeding end to the receiving end is maximized. Loss occurring at the connecting interface can take the form of reflection, refraction, scattering and absorption. In the ideal situation, the end faces of the two fibers have a perfect match, no gap is left, and hence light transmits as if in a continuous fiber without experiencing any change of transmission medium. In real life, perfect match of the end faces is difficult, if not impossible, to achieve. Therefore, index-matching oil and/or index-matching solid intermediate materials have been proposed previously to be included between the two connecting end faces, filling in any gap that would have otherwise been caused without the intermediate material. The index-matching intermediate materials are desired to have a refractive index as close to the fiber cores as possible. As mentioned supra, these techniques can reduce the transmission loss at the connection interface; but there is still room for improvement; hence the advent of the present invention.

Field installable mechanical optical splice connectors can contain a refractive-index-matching material in the connector's splice section to improve the quality of the optical connection between the connector's internal fiber (fiber stub) and the fiber the connector is being installed upon (field fiber). This index matching material can be applied in the factory when the connector is assembled such that it resides in the connector's mechanical splice section, on or around the connector's internal fiber stub. During installation, the index matching material is trapped between the fiber stub and field fiber, filling the gap between the two mating fibers and providing reduced insertion loss and back reflection by reducing changes in index of refraction in the optical path.

While index matching materials are typically silicone-based liquids or gels, there also exist solid index matching materials. When deployed in a mechanical splice connector, these solid materials provide the same benefits of improved optical performance due to reduction in the air gap between the fiber stubs. Additionally, these solid materials may be formulated to provide superior optical performance, particularly during exposure to temperature extremes. However, they do not possess the lubrication properties inherent to silicone oils and gels. It has been discovered that in the case of field installable mechanical splice connectors, without the lubrication, it is likely that the splice parts, which are typically made from a thermoplastic, or the fiber will be damaged (gouged or skived) during fiber installation. The skiving of the splice parts may result in two problems: a) the damage to the splice parts can result in reduced optical performance due to impaired fiber alignment b) the plastic material that is skived off the splice surface can become entrapped between the mating fiber in the optical path. In either case, the performance of the connector is impaired.

### 1. Overall Structure of an Optical Assembly of the Present Invention

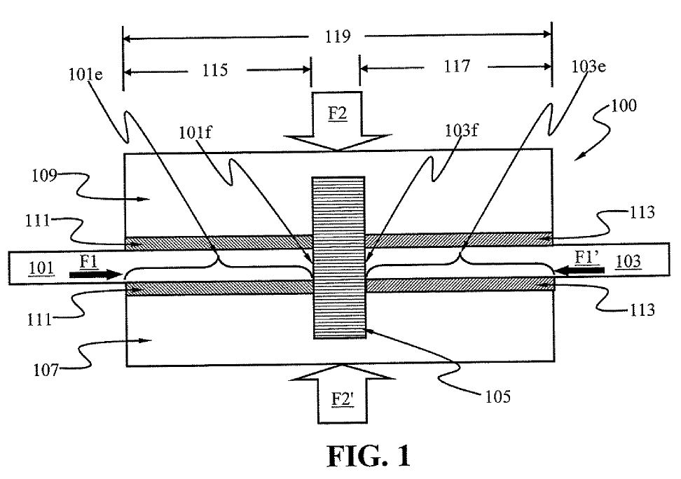

FIG. 1 is a schematic illustration of the structure of an optical assembly 100 including a fiber-to-fiber connection according to one embodiment of the present invention. In this assembly, a first fiber 101, which is a first optical transmission medium in the meaning of the present invention, is connected to a second fiber 103, which is a second optical transmission medium in the meaning of the present invention, via an intermediate index-matching material 105 interposed between the end face 101f of the first end portion 101e of the first optical fiber 101 and the end face 103f of the second end portion 103e of the second optical fiber 103. Desirably, an external force F1 is exerted on the first fiber 101, and an external force F1′ is exerted on the second fiber 103, such that the end faces of the fibers 101f and 103f are pressed against the intermediate index-matching material 105. One or both of the end faces 101f and 103f may be bonded to the intermediate index-matching material 105 via, e.g., an adhesive, such as a pressure-sensitive adhesive, an epoxy, and the like. It is desired that between the end faces 101f, 103f and the intermediate index-matching material 105, there is essentially no air gap left. The presence of an air gap between the end face and the index-matching material can lead to unwanted reflection, diffraction, scattering, hence loss of transmitted light.

The first end portion 101e of the first fiber 101 is located within a first enclosure 115, and the second end portion 103e of the second fiber 103 is located within a second enclosure 117. Between the internal surface of the first enclosure 115 and the external surface of the first end portion 101e, a layer of lubricating material 111 is present. Likewise, in this embodiment, between the external surface of the second end portion 103e and the internal surface of the second enclosure 117, a layer of lubricating material 113 is present. In this embodiment as illustrated, the first enclosure 115 and the second enclosure 117 together form a single, long enclosure 119 capable of housing the end portions of both fibers. The enclosure 119 can be a mechanical splice, which includes a top portion 109 and a lower portion 107. External forces F2 and F2′ can be exerted on the top and lower portions of the splice, via, e.g., a mechanical clamp (not shown), holding the splice in unity, and fixing the end portions of the fibers in place, ensuring the alignment of the end faces 101f and 103f, as well as the mechanical stability of the connection.

### 2. Process

The optical connection process of the present invention can be used to connect, inter alia, a field fiber to a fiber connector, or a field fiber to a field fiber, where transmission loss can be reduced by using the present invention.

For example, in the case of field fiber to fiber connector connection, 101 as illustrated in FIG. 1 can be a field fiber, and 103 can be the stub fiber in a pre-fabricated fiber connector. Various fiber connectors can be utilized in the present invention. For example, the present invention can be used to connect a field optical fiber with a modified UniCam® optical fiber connector manufactured by Corning Cable Systems, LLC, Hickory, N.C., U.S.A. By including an intermediate index-matching material such as a film between the end face of the field fiber and the end face of the stub fiber, and by using a lubricating material on the external surface of the end portion of the field fiber to be inserted into the fiber connector for connection, an enhanced connection between the field fiber and the fiber connector can be achieved. The intermediate index-matching material can be included into a modified connector manufactured in the plant, thus reducing the complexity of field installation of the connector to the end of the field fiber. The lubricating material between the end portion of the field fiber and the splice can be pre-applied to the internal surface of the splice or to the external surface of the end portion of the fiber to be connected, which serves as the first enclosure for the end portion of the field fiber, during the manufacture of the connector, thus further reducing the steps and complexity of the field installation of the field fiber to the connector.

In case of field-fiber-to-field-fiber connection, both fibers 101 and 103 can be, e.g., long-haul field fibers to be joined directly by utilizing the process of the present invention. Such direct field-fiber-to-field-fiber connection can reduce the total number of connectors used in the optical network, hence the complexity of the system, transmission loss and costs, and enhance the overall reliability of the whole system. The inclusion of the intermediate index-matching material can achieve a tight connection without the need of precision grinding and polishing of the fiber end faces.

The inclusion of the lubricating material between the end portion of the field fiber and the enclosure thereof facilitates the insertion of the fiber ends into the enclosure and the easy and successful attachment of the end face of the field fiber to the surface of the intermediate index-matching material.

It has been found that, surprisingly, the inclusion of the lubricating material reduces average transmission loss and transmission loss variability of the connection as well, even if the lubricating material does not enter into the light path of the light to be transmitted. Without intending to be bound by a particular theory, it is believed that this is due to the reduction of the scratching and chipping of the fiber end faces during the connection. The end portion of the field fiber is typically clipped before the intended connection. It is believed that, without further polishing and grinding, mechanical clipping results in sharp and/or irregular edge profiles of the end face of the fiber. Without the presence of a lubricating material between the end portion of the fiber and the enclosure, the end face of the fiber can scratch the internal surface of the enclosure, leading to further unwanted chipping of the fiber end face, inclusion of enclosure materials (such as plastic materials) and/or the chipped fiber material in the light path, thereby causing unwanted transmission loss. Moreover, the gouging and skiving of the internal surface of the enclosure can cause unwanted dimensional and geometric alteration of the surface, leading to less precise alignment between the fiber end faces, which can cause transmission loss and transmission loss variability.

### 3. Fibers

Various fibers can be connected by using the process of the present invention to form an optical connection assembly according to the present invention. The intermediate index-matching material and the lubricating material to be used can be adjusted for various fiber types and materials to provide the desired robust and high-quality connection. The present invention is particularly advantageous for use with low-loss optical fibers which are typical components of low-loss optical transmission networks, such as those used in long-distance, regional, and residential optical networks.

The present invention can be used to connect a single fiber to a single fiber, or a fiber array/bundle to a fiber array/bundle, as long as the end faces of the fibers to be connected are properly aligned.

The end faces of the fibers to be connected according to the present invention can be flat or angled. In actual fiber deployment, it is typical to cleave the fiber ends to have an angle. The angles of the two fiber ends can be allowed to supplement each other to minimize the gap between the end faces; or alternatively, the fiber end faces may be not aligned, leaving a relatively large gap therebetween.

### 4. The Intermediate Index-Matching Material

The intermediate index-matching material is desirably a solid at around room temperature. By “solid” is meant that the material has a sufficiently high viscosity at room temperature such that its shape can be substantially maintained without external forces. On the other hand, the intermediate index-matching material may be a viscous liquid or a gel, such as a silicone gel, a petroleum oil, and the like. In certain embodiments the material comprises an organic polymer. In certain embodiments, the material comprises a surface adhesive, such as a pressure-sensitive adhesive, to facilitate the attachment of the fiber end faces thereto. A particular example of the polymer is poly(meth)acrylates. A product that can be utilized as the material is Fitwell® commercialized by Tomoegawa, 1-5-15 Kyobashi, Chuo-ku, Tokyo, Japan. European Patent Application Publication No. EP 1 686 401 contains extensive description of materials that could be used for the intermediate index-matching layer, the relevant portions thereof are incorporated herein by reference in their entirety.

It was found that it is generally desired that the intermediate index-matching material has a thickness of at least 10 μm, in certain embodiments at least 15 μm, in certain embodiments at least 20 μm, in certain embodiments at least 25 μm, in certain embodiments at least 20 μm. If the thickness of the intermediate index-matching material is too small, transmission loss and transmission loss variation can be overly large. Without intending to be bound by any theory, it is believed this is due to possible remaining air gap between the fiber end face and the intermediate index-matching material.

### 5. Lubricating Material

The lubricating material functions to lower the friction between the end portions of the fibers to be connected and the internal surface of the enclosures when the fiber is inserted into the enclosure. The lubricating material thus protects both the end faces of the fibers and the internal surface of the enclosures during insertion. As mentioned supra, the lubricating material can be applied in-situ during the installation of the connection, or pre-applied to the parts to be connected, such as the end portions of the fibers to be connected, the internal surfaces of the enclosures, or both. Alternatively, the lubricating material can be pre-applied well before the installation of the connection. Alternatively, the lubricating material may be formed into the composition of the material for making the enclosure, such that no additional lubricating material is needed. The lubricating material can be a solid, a gel, a liquid, a dispersion such as a suspension, an emulsion, or combinations thereof. Certain thixotropic lubricants are particularly advantageous. The lubricating material may form a thin layer of film (which can be a solid, liquid or gel film), a coating, a stripe, or other shape, between the end portion of the fiber and the internal surface of the enclosure. Examples of the lubricating material include, but are not limited to: polytetrafluoroethylene (such as film, emulsion and the like); silicone gel; silicone oil; petrolatum, and the like. It is desired in certain embodiments that the lubricating material is a transparent material for the light to be transmitted through the connection. It is further desired in certain embodiments that the lubricating material has a refractive index matching that of the core of the fibers to be connected. Such transparent, index-matching lubricating material would not interfere with the transmission of light if trapped between the fiber end face and the intermediate index-matching material.

However, it should be noted that, as long as the lubricating material does not enter into the interface between the fiber end face and the intermediate index-matching material, it is not critical that the lubricating material to be transparent or have a matching refractive index to that of the fiber core.

It is contemplated that a fugitive lubricating material may be employed in the present invention. By “fugitive lubricating material” is meant a material that functions as a lubricant during the installation of the connection, but subsequently evaporates. An example of such fugitive lubricating material is isopropyl alcohol, which lubricates the interface between the fiber outer layer and the enclosure housing the fiber, and evaporates over time after installation is completed. Since such fugitive lubricating material tends to be a volatile solvent, care should be taken that the choice thereof should be compatible with the fiber material, the enclosure material and the intermediate index-matching material. A combination of a plurality of lubricating materials may be used at the interface between the fiber and the enclosure.

### 6. Splice as the Enclosure for the Fibers

As mentioned supra, splices may be used as the enclosures for housing the fibers to be connected. Splices are used widely in optical fiber connectors. In splices, end portions of optical fibers are secured, precisely aligned and protected. A splice may comprise multiple pieces, or a single tube, to form a complete enclosure for housing the end portions of the fibers. Alternatively, the splice may enclose the end portions of the fibers only partially at one location or another, as long as the splice provides the desired level of alignment, protection and position stability. Where the splice comprises multiple pieces, those pieces may comprise an interlocking structure and mechanism to ensure the integrity, unity and strength thereof needed by the connection. The splice may be further enclosed by additional packaging and/or protection enclosures, such as clamps, boots, splices, and the like.

Although optic fiber connectors are most efficiently and reliably mounted upon the end portion of an optical fiber in a factory setting, many optic fiber connectors must be mounted upon the end portion of an optical fiber in the field in order to minimize cable lengths and to optimize cable management and routing. As such, a number of optic fiber connectors have been developed specifically to facilitate field installation. One advantageous type of optic fiber connector that is designed specifically to facilitate field installation is the UniCam® family of field-installable optic fiber connectors available from Corning Cable Systems LLC of Hickory, N.C. Although the UniCam® family of field-installable connectors includes a number of common features including a common termination technique (i.e., mechanical splice), the UniCam® family also offers several different styles of connectors, including mechanical splice connectors adapted to be mounted upon a single optical fiber and mechanical splice connectors adapted to be mounted upon two or more optical fibers. Regardless, each such field-installable connector requires an apparatus for performing the splice termination and thereafter determining whether the continuity of the optical coupling between the field fiber and the stub fiber of the connector is acceptable. Typically, a splice termination is acceptable when a variable related to the optical performance of the connector, such as insertion loss or reflectance, is within a prescribed limit or threshold value.

Installation tools have been developed to facilitate the splice termination of one or more optical fibers to a optic fiber connector, and particularly, to enable the splice termination of one or more field optical fibers to a mechanical splice connector. Examples of conventional installation tools for performing mechanical splices in the field are described in U.S. Pat. Nos. 5,040,867; 5,261,020; 6,816,661; and 6,931,193. In particular, U.S. Pat. Nos. 6,816,661 and 6,931,193 describe a UniCam® installation tool available from Corning Cable Systems LLC of Hickory, N.C., designed specifically to facilitate mounting the UniCam® family of optic fiber connectors upon the end portions of one or more field optical fibers. Such an installation tool typically supports a mechanical splice connector, including a ferrule and the splice components, while a field optical fiber is inserted into the connector and aligned with a stub optical fiber. In this regard, the installation tool generally includes a tool base, a tool housing positioned on the tool base, and an adapter provided on the tool housing. The adapter has a first end for engaging the mechanical splice connector that is to be mounted upon the field optical fiber, and an opposed second end that serves as a temporary adapter. The forward end of the mechanical splice connector is received within the first end of the adapter, which in turn is positioned on the tool housing. The end portion of the field optical fiber is then inserted and advanced into the open rear end of the mechanical splice connector and the splice components are subsequently actuated, for example biased together by engagement of the cam member with at least one of the splice components, in order to secure the stub optical fiber and the field optical fiber between the splice components.

The connector installation tool and methods described United States Patent Application Publication No. 2007/0172179 are applicable to performing splice terminations and verifying the continuity of the optical couplings between any pair of interconnected optical fibers, and more particularly, between a field optical fiber and an optical fiber of any optic fiber splice connector, including a single fiber or multi-fiber fusion splice or mechanical splice connector. Examples of typical single fiber mechanical splice connectors are provided in U.S. Pat. Nos. 4,755,018; 4,923,274; 5,040,867; and 5,394,496. Examples of typical multi-fiber mechanical splice connectors are provided in U.S. Pat. Nos. 6,173,097; 6,379,054; 6,439,780; and 6,816,661.

### 7. A Specific Embodiment Employing UniCam® Connector

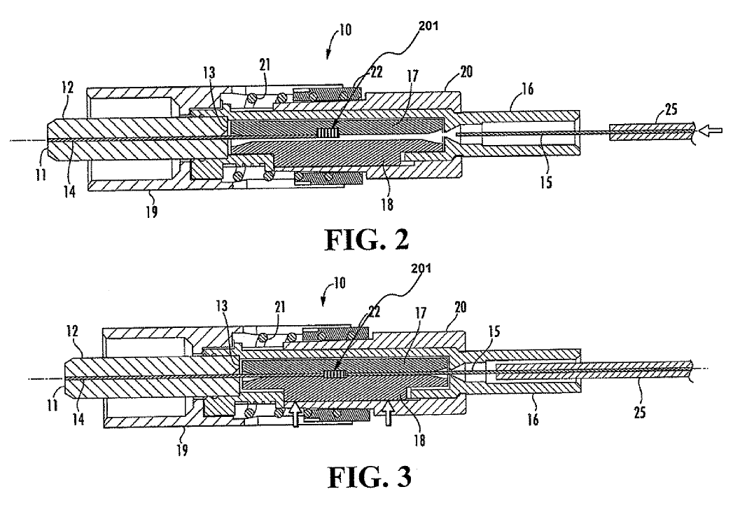

Referring to FIG. 2 and FIG. 3, a modified conventional field-installable, mechanical splice optic fiber connector 10 suitable for use with the present invention is shown. The optic fiber connector 10 is modified from a member of the UniCam® family of mechanical splice connectors available from Corning Cable Systems, LLC of Hickory, N.C., U.S.A., the modification being the inclusion of a polymer-based, intermediate index-matching film 201 inside the splice, to be interposed between the end faces of the field fiber and the fiber stub. FIG. 2 shows the assembly before installation is completed; and FIG. 3 shows the assembly upon completion of the installation. As shown herein, the mechanical splice connector 10 includes a connector ferrule 12 defining a lengthwise, longitudinal bore for receiving and securing a stub optical fiber 14 in a known manner, such as by an adhesive. The forward end (also referred to herein as the end face) 11 of the ferrule 12 is typically precision polished such that the stub optical fiber 14 is flush with (as shown) or slightly protruding from the end face of the ferrule 12. However, the stub optical fiber 14 may also protrude outwardly from the end face 11 of the ferrule 12 a predetermined distance, if desired. Furthermore, the end face 11 may be oriented generally perpendicular to the bore to provide an Ultra Physical Contact (UPC) type connector, or may be formed at a predetermined angle to provide an Angled Physical Contact (APC) type connector, in a known manner. In addition, although a single fiber ferrule 12 is shown for purposes of convenience, the ferrule 12 may define a plurality of is lengthwise bores therethrough for receiving a corresponding plurality of stub optical fibers to provide a multi-fiber mechanical splice connector.

The rear end 13 of the ferrule 12 is inserted into and secured within the forward end of a ferrule holder 16 so that the stub optical fiber 14 extends rearwardly a predetermined distance from the ferrule between a pair of opposed splice components 17, 18 disposed within the ferrule holder. The rear end face of the stub fiber 14 is in close contact with a polymer-based, index-matching intermediate material 201, desirably without any air gap therebetween. In turn, the ferrule holder 16, including the ferrule 12 and splice components 17, 18, is disposed within a connector housing 19. A cam member 20 is movably mounted between the ferrule holder 16 and the connector housing 19 for engaging a keel portion of the lower splice component 18. A thin layer of lubricating material (not shown in FIG. 3), such as silicone gel, and the like, is present between the end portions of fiber 15 and the splice components 17, 18 in FIG. 3. The lubricating material is desirably present at least on the internal surface of splice component 17 in FIG. 2 to facilitate the insertion of the fiber 15 without skiving or gouging. If desired, the ferrule 12, the ferrule holder 16 and the cam member 20 may be biased relative to the connector housing 19, for example by a coil spring 21, to ensure physical contact between the end face 11 of the ferrule 12 and the end face of an opposing ferrule in a mating optic fiber connector or optical device. Finally, a spring retainer 22 may be disposed between the connector housing 19 and a medial portion of the cam member 20 and fixed to the connector housing so as to retain one end of the spring 21 relative to the connector housing. As a result, the ferrule 12, the ferrule holder 16 and the cam member 20 are biased forwardly, yet permitted to piston rearwardly relative to the connector housing 19.

As illustrated by the horizontal directional arrow in FIG. 2, a field optical fiber 15 is inserted into the rear end of the ferrule holder 16 opposite the ferrule 12 and the stub optical fiber 14. Although not required, the mechanical splice connector 10 may be provided with a means, for example a lead-in tube (not shown), for guiding the field optical fiber 15 into the ferrule holder 16 and between the splice components 17, 18 in general alignment with the stub optical fiber 14. Desirably, at least one of the splice components 17, 18 has a groove formed therein for receiving the stub optical fiber 14 and the field optical fiber 15. As mentioned above, a lubricant is provided at least on the internal surface of splice component 17, desirably also on the internal surface of the splice component 18, to facilitate the insertion of the fiber 15 into the groove without scratching, gouging and/or skiving. As shown herein, the lower splice component 18 is provided with a lengthwise V-shaped groove for receiving and guiding the stub optical fiber 14 and the field optical fiber 15 into fine alignment with the intermediate index-matching film 201. Typically, the field optical fiber 15 is coated or tight-buffered with a buffer 25 that is stripped back to expose a predetermined length of the end of the field optical fiber. The mechanical splice connector 10 may be further provided with a crimp tube or other strain relief mechanism (not shown) for retaining and strain relieving the buffer 25 of the field optical fiber 15. With the buffer 25 removed, the field optical fiber 15 can be inserted and advanced into the rear of the mechanical splice connector 10 between the splice components 17, 18, with the aid of the lubricant (not shown), until the end portion of the field optical fiber 15 makes physical contact with the intermittent index-matching material 201, which, in turn, makes physical contact with the end face of the stub optical fiber 14. The cam member 20 is actuated by moving or rotating the cam member 20 relative to the ferrule holder 16 about the longitudinal axis of the connector 10, to engage the keel on the splice component 18 and thereby force the lower splice component 18 in the direction of the upper splice component 17, as illustrated by the vertical directional arrows in FIG. 3. Movement of the lower splice component 18 causes the end portion of the stub optical fiber 14 and the end portion of the field optical fiber 15, as well as the intermediate, index-matching film 201 to seat within the V-shaped groove formed in the lower splice component 18, thereby aligning and simultaneously securing the field optical fiber 15 relative to the stub optical fiber 14 between the splice components, with the intermediate index-matching material 201 inserted in between. Accordingly, the field optical fiber 15 is optically coupled to the stub optical fiber 14. Further, as used herein, the portion of the connector where the optical coupling results is referred to as a “termination area.”

If the continuity of the optical coupling between the field optical fiber 15 and the stub optical fiber 14 is acceptable (e.g., the insertion loss is less than a prescribed value and/or the reflectance is less than a prescribed value), the cable assembly can be completed, for example by strain relieving the buffer 25 of the field optical fiber to the splice connector 10. In the event that the field optical fiber 15 is not in physical contact with the intermediate index-matching material 201 or is not properly aligned with the stub optical fiber 14, significant attenuation and/or reflectance of the optical signal transmitted along the optical fibers may occur. A slight amount of attenuation and/or reflectance is inevitable at any optical coupling due to the fact that the cores of the optical fibers are not truly concentric and the joint between the optical fibers cannot be formed with the same precision as a continuous optical fiber.

Installation tools mentioned above can be used to carry out the process of the present invention to make the optical assembly of the present invention.

The present invention is further illustrated by the following non-limiting examples.

### EXAMPLES

A plurality of UniCam® single-fiber connectors, available from Corning Cable Systems, LLC, Hickory, N.C., U.S.A., were modified by attaching an index-matching flexible, polymer-based film having a thickness of about 30 μm at the end face of the stub fiber to be connected with a field fiber (see FIGS. 2 and 3). The minimum, maximum, average thicknesses, as well as the standard deviation of the average thickness of the polymer-based films of more than 20 samples in total are reported in TABLE I.

The modified fiber connectors were subsequently installed onto 900 μm SMF-28 fiber, available from Corning Cable Systems, LLC, Hickory, N.C., U.S.A., following the standard installation procedure (SRP006-150) by using standard installation equipment, both available form Corning Cable Systems, LLC. Upon installation, the optical performance of the samples was determined by measuring them against a Master Test Jumper using a reflectometer. Insertion loss and reflectance loss were recorded at 1310 and 1550 nm wavelengths. Minimum, maximum and average losses, as well as standard deviation thereof, are included in TABLE I below.

The samples thus prepared and tested were divided into two sets each having more than 10 samples. In the First Set (1^{st} Set), the connectors were installed on the fibers without the use of an extra lubricant between the fiber and the connector. In the Second Set (2^{nd} Set), the connectors were installed on the fibers with the aid of a silicone gel lubricant (Nye OC-431A, available from Nye Lubricants, Inc., Fairhaven, Mass., U.S.A.). The lubricant was injected into the connector according to the standard installation procedure of a non-modified UniCam® connector.

Fibers in TABLE I were processed to have oriented cleaved angles upon installation.

As can be seen from the results in TABLE I, The samples built using the polymer-based intermediate film alone exhibited a higher average insertion loss and standard deviation thereof than those built using a combination of the index-matching polymer-based intermediate film material and Nye OC-431A lubricating gel. Dissection of the parts built without the lubricant revealed a significant amount of plastic debris in the optical path. Debris was found to be generated by the sliding motion of the glass fiber against the plastic splice part during installation of the connector. This debris was not found in the parts that contained Nye OC-431A gel.

In TABLE I, the fiber in these connector samples was cleaved such that the end face was at a 6-8° angle relative to the normal of the fiber axis (which is a standard practice to minimize reflection at the cleave). When 2 fibers with angled cleaves are brought together endwise, they can be rotationally oriented relative to each other such that the angles are complimentary and minimize the gap between the end faces of the fibers, or they can be positioned non-complimentary such that the gap between the end faces of the fibers is relatively large. In this case, “nonaligned cleave angles” means the angles of the end faces are non-complimentary. “Oriented Cleave Angles” are cleaves that are rotationally positioned such that the cleave faces are complimentary, and the gap between the connecting end faces is reduced. The present invention provides improvement in both oriented cleave angles and non-aligned cleave angles. The fibers for which data are provided in TABLE I had oriented cleave angles when connected.

In TABLE I, IL is an abbreviation of Insertion Loss. It is a calculated change in optical through-power in an optical path. It is calculated as follows (in decibels):

IL=10 log[(Incident Power)/(Output Power)]

In TABLE I, RL is an abbreviation of Return Loss. It is the ratio of light injected into a system to the amount of light reflected back. It is calculated as follows:

RL=10 log[(Incident Power)/(Reflected Power)].

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

TABLE I

| | Film | IL | | | | RL | | | |
|---|---|---|---|---|---|---|---|---|---|
| | Thickness | @1310 nm | | @1550 nm | | @1310 nm | | @1550 nm | |
| | (μM) | 1st Set | 2nd Set | 1st Set | 2nd Set | 1st Set | 2nd Set | 1st Set | 2nd set |
| MIN | 25.3 | 0.22 | 0.29 | 0.24 | 0.32 | 42 | 60 | 38 | 60 |
| MAX | 33.7 | 4.68 | 0.77 | 4.17 | 0.75 | 75 | 66 | 75 | 69 |
| AVG | 29.3 | 1.42 | 0.51 | 1.23 | 0.47 | 68 | 64 | 68 | 65 |
| STDEV | 2.81 | 1.71 | 0.16 | 1.45 | 0.13 | 10 | 2.1 | 12 | 3.0 |

Notes:
MIN: minimum measured value;
MAX: maximum measured value;
AVG: average measured values of all samples;
STDEV: Standard deviation of average value;
IL: insertion loss;
RL: return loss.

1. A method for mechanically and optically connecting a first end face of a first optical transmission medium and a second end face of a second optical transmission medium, comprising:
(A) providing a first enclosure capable of housing a first end portion of the first optical transmission medium comprising the first end face;
(C) providing an intermediate indexmatching material between the first end face and the second end face;
(D) providing a lubricating material between the first end portion of the first optical transmission medium and the first enclosure; and
(E) moving the first end face of the first optical transmission medium relative to the second end face of the second optical transmission medium by engaging the first end portion with the first enclosure, thereby bringing the first end face of the first optical transmission medium and the second end face of the second optical transmission medium into contact with the intermediate indexmatching material.

2. A method according to claim 1, further comprising the following step (B) before step (E) is carried out:
(B) providing a second enclosure capable of housing a second end portion of the second optical transmission medium comprising the second end face.

3. A method according to claim 1, wherein the intermediate indexmatching material provided in step (C) is a solid material at room temperature.

4. A method according to claim 1, wherein the first optical transmission medium comprises a core of a first optical waveguide, and the second optical transmission medium comprises a core of a second optical waveguide.

5. A method according to claim 1, wherein the first optical transmission medium comprises a plurality of optical fibers.

6. A method according to claim 1, wherein the intermediate indexmatching material provided in step (C) is a deformable organic polymer.

7. A method according to claim 6, wherein the intermediate indexmatching material provided in step (C) has a pressuresensitive surface on the side to be in contact with the first end face.

8. A method according to claim 1, wherein the lubricating material provided in step (D) comprises a liquid, a gel, a suspension, or an emulsion.

9. A method according to claim 8, wherein the lubricating material comprises a lubricating oil.

10. A method according to claim 8, wherein the lubricating material comprises a fugitive lubricant.

11. A method according to claim 1, wherein step (D) comprises applying the lubricating material to the external surface of the first end portion of the first optical transmission medium, and/or to the internal surface of the first enclosure.

12. A method according to claim 11, wherein at least part of the lubricating material is applied in situ immediately before the first end face and the second end face are connected.

13. A method according to claim 11, wherein at least part of the lubricating material is included in (i) the material forming the external surface of the first end portion of the first optical transmission medium, and/or (ii) the material forming the internal surface of the first enclosure.

14. An optical assembly comprising a first optical transmission medium and a second optical transmission medium, which are optically and mechanically connected via a first end face of the first optical transmission medium and a second end face of the second optical transmission medium, comprising:
(a) a first enclosure housing a first end portion of the first optical transmission medium comprising the first end face;
(c) an intermediate indexmatching material between the first end face and the second end face; and
(d) a lubricating material between the first end portion of the first optical transmission medium and the first enclosure.

15. An optical assembly according to claim 14, further comprising the following:
(b) a second enclosure housing a second end portion of the second optical transmission medium comprising the second end face.

16. An optical assembly according to claim 14, wherein the intermediate indexmatching material between the first end face and the second end face is a solid material at room temperature.

17. An optical assembly according to claim 14, wherein the first optical transmission medium comprises a core of a first optical waveguide, and the second optical transmission medium comprises a core of a second optical waveguide.

18. An optical assembly according to claim 14, wherein the intermediate indexmatching material (c) is a deformable organic polymer.

19. An optical assembly according to claim 14, wherein the lubricating material (d) comprises a liquid, a gel, a suspension, or an emulsion.

20. An optical assembly according to claim 19, wherein the lubricating material comprises a lubricating oil.

21. An optical assembly according to claim 14, wherein the lubricating material is present substantially only between the external surface of the first end portion of the first optical transmission medium, and the internal surface of the first enclosure.

22. An optical assembly according to claim 14, wherein at least part of the lubricating material is included in (i) the material forming the external surface of the first end portion of the first optical transmission medium, and/or (ii) the material forming the internal surface of the first enclosure.

23. An optical assembly according to claim 14, wherein the first enclosure comprises a splice.

24. An optical assembly according to claim 14, wherein the intermediate indexmatching material (c) has a thickness of larger than 10 μm.
